(19) United States
(12) Patent Application Publication
(10) Pub. No.: US 2007/0070546 A1
(43) Pub. Date: Mar. 29, 2007

(54) DATA STORING MEDIUM AND HARD DISK DRIVE HAVING THE SAME

(76) Inventor: Sung-chul KIM, Suwon-si (KR)

Correspondence Address: STANZIONE & KIM, LLP, 919 18TH STREET, N.W., SUITE 440, WASHINGTON, DC, 20006, US

(21) Appl. No.: 11/466,887

(22) Filed: Aug. 24, 2006

(30) Foreign Application Priority Data
Sep. 23, 2005 (KR) 10-2005-0088719

(51) Int. Cl. G11B 5/82

(52) U.S. Cl. 360/135

(57) ABSTRACT

A data storing medium and a hard disk drive (HDD) having the data storing medium. The data storing medium includes a recording zone where data is recorded and/or reproduced, and a non-recording zone disposed outside the recording zone to overlap with an end of a ramp at which a slider is parked, the non-recording zone including a plurality of micro bumps formed thereon to reduce adsorption between the slider and a surface of the data storing medium. The HDD includes a disk-shaped data storing medium, a slider with a magnetic head to record and/or read data to/from the data storing medium, and a ramp arranged at an outer edge of the data storing medium in which of the slider is parked.

### CROSS-REFERENCE TO RELATED APPLICATIONS

This application claims the benefit of Korean Patent Application No. 10-2005-0088719, filed on Sep. 23, 2005, in the Korean Intellectual Property Office, the disclosure of which is incorporated herein in its entirety by reference.

### BACKGROUND OF THE INVENTION

1. Field of the Invention

The present general inventive concept relates to a hard disk drive (HDD), and more particularly, to a data storing medium to enable stable unloading of a slider, and a HDD having the same.

2. Description of the Related Art

A hard disk drive (HDD) is an example of an auxiliary memory used in computers, MP3 players, mobile phones, etc., for storing and reproducing data on a data storing medium using a magnetic head. In the HDD, the magnetic head records or reads data by moving to a specific position of the data storing medium, while floating above a surface of the data storing medium, which rotates at high speed.

When power for operating the HDD is off, the magnetic head is parked outside of the data storing medium so as not to collide with the data storing medium. Parking systems can be classified as a CSS (contact start stop) system or a ramp system.

In the CSS system, a parking zone is arranged at an inner edge of the data storing medium, and a slider having the magnetic head thereon comes into contact with and is parked on the parking zone by bringing the slider into contact with the parking zone. In the ramp system, a ramp is arranged at an outer edge of the data storing medium, and the slider is parked on the ramp. In the CSS system, there is a high possibility that the slider and the data storing medium may be damaged by an exterior impact, since a head stack assembly (HSA) is not fixed. For this reason, the CSS system is not suitable for mobile environments that have been recently developed. Thus, the ramp system is typically used in the mobile environments.

FIG. 1 illustrates a problem associated with unloading a magnetic head in a conventional HDD.

With reference to FIG. 1, when the conventional HDD is in operation, air-flow induced by a high speed rotation of a data storing medium 10 causes a lift force on a slider 15. As a result, the slider 15 maintains a floating height “d” above a surface of the data storing medium 10, where the lift force and an elastic force of a head stack assembly (HSA) (not shown) are equal. As illustrated by an arrow in FIG. 1, when power that operates the HDD is shut off, the slider 15 with a magnetic head (not shown) moves to an outer edge of the data storing medium 10. When an end-tap 17 at an end of the HSA (not shown) moves along a slope 22 of a ramp 20, the slider 15 is spaced from the surface of the data storing medium 10 and parked outside of the data storing medium 10. This is known as unloading the magnetic head.

When the operation of the HDD stops and thus the rotation speed of the data storing medium 10 converges to zero, the lift force of the slider 15 decreases while a suction force which attracts the slider 15 to the surface of the data storing medium 10 increases. Thus, the end-tap 17 may not move upward along the slope 22 of the ramp 20, since the slider 15 attaches to the surface of the data storing medium 10 as illustrated in a first state (i), or the end-tap 17 in a middle of the slope 22 as illustrated in a second state (ii). An unloading failure is very likely in a small HDD where inertia of the data storing medium 10 and the HSA is low, the rotation speed of the data storing medium 10 is low, and the floating height “d” of the slider 15 is low. The unloading failure is particularly likely in an emergency unloading state caused by a power failure. On the other hand, when a movement speed of the HSA increases to prevent the unloading failure, other problems may occur, such as a greater possibility that particles are released when the end-tap 17 collides with the slope 22 at the increased movement speed.

### SUMMARY OF THE INVENTION

The present general inventive concept provides a data storing medium having a number of micro bumps formed thereon to restrain a slider from being pushed toward an outer edge, and a hard disk drive (HDD) having the same.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a data storing medium including a recording zone where data is recorded and/or reproduced, a non-recording zone disposed outside the recording zone to overlap with an end of a ramp on which a slider with a magnetic head is parked, the non-recording zone including a plurality of micro bumps formed thereon to reduce adsorption between the slider and a surface of the data storing medium.

The micro bumps may be formed by irradiating laser light on the surface of the data storing medium.

The micro bumps may be 0.1 um or less in height.

The non-recording zone may include a bump region adjacent to an outer edge of the data storing medium and having the micro bumps distributed therein, and a boundary region arranged between the recording zone and the bump region.

The bump region may be 0.23 mm or less in width.

The boundary region may be 0.23 mm or less in width.

The foregoing and/or other aspects of the present general inventive concept are also achieved by providing a hard disk drive (HDD) including a disk-shaped data storing medium, a slider with a magnetic head to record and/or reproduce data to/from the data storing medium, and a ramp arranged in an outer edge of the data storing medium on which the slider is parked. The data storing medium includes a recording zone where data is recorded and/or reproduced, and a non-recording zone arranged outside the recording zone to overlap with an end of the ramp and having a plurality of micro bumps formed thereon to prevent adsorption between the slider and a surface of the data storing medium.

The micro bumps may be formed by irradiating laser light on the surface of the data storing medium.

The micro bumps may be 0.1 um or less in height.

The non-recording zone may include a bump region adjacent to an outer edge of the data storing medium and having the micro bumps distributed therein, and a boundary region arranged between the recording zone and the bump region.

The bump region may be 0.23 mm or less in width.

The boundary region may be 0.23 mm or less in width.

The foregoing and/or other aspects of the present general inventive concept are also achieved by providing a hard disk drive, including a hard disc including a recording region in which data is recordable and readable, and a non-recording region disposed around the recording region and having a plurality of irregularities formed thereon, a slider having a magnetic head associated therewith and being movable along the recording and non-recording regions, and a ramp on which the slider is parkable when the hard disk drive is powered off and having a slope extending over the non-recording surface.

The foregoing and/or other aspects of the present general inventive concept are also achieved by providing a method of manufacturing a hard disc usable with a hard disk drive, the method including irradiating a laser onto an outer ring of the hard disc to expand a surface of the hard disc such that a plurality of bumps are formed in the outer ring of the hard disc.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates a problem associated with unloading a magnetic head in a conventional hard disk drive (HDD);

FIG. 2 is a plan view illustrating a HDD in accordance with an embodiment of the present general inventive concept;

FIG. 3 is a partial perspective view illustrating the HDD of FIG. 2;

FIG. 4 is a plan view illustrating a part of a data storing medium of the HDD of FIG. 2; and

FIG. 5 illustrates unloading of a magnetic head of the HDD of FIG. 2, in accordance with an embodiment of the present general inventive concept.

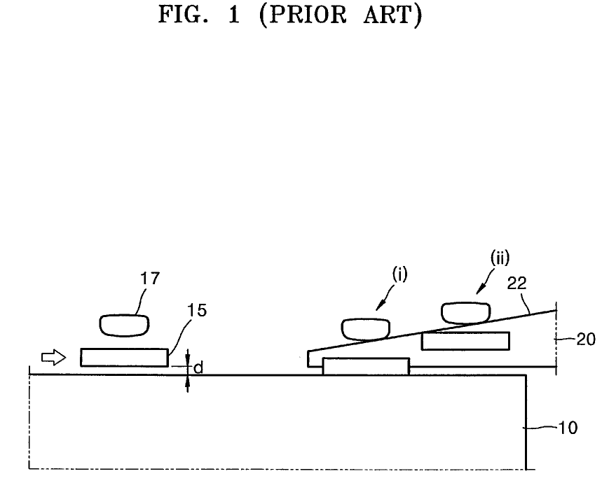

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

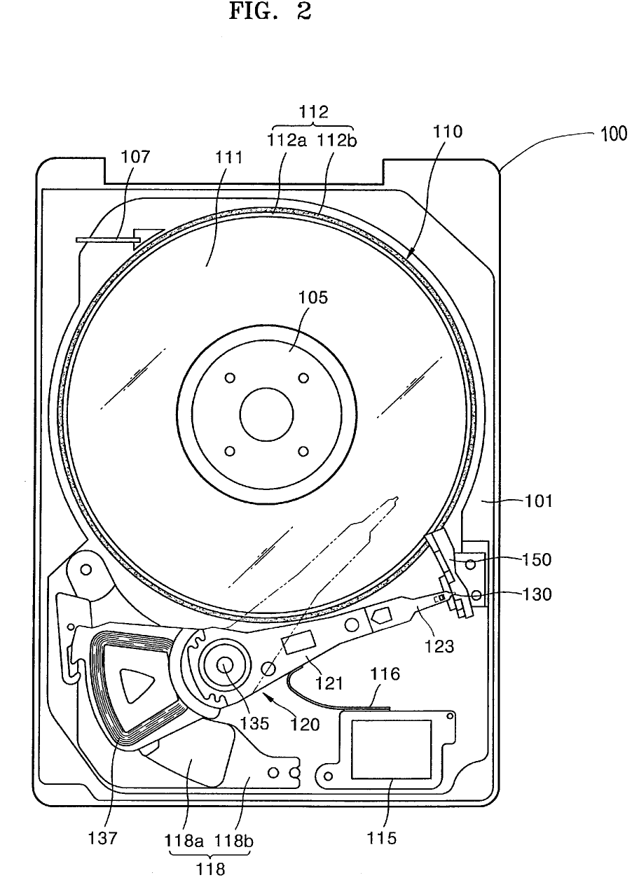

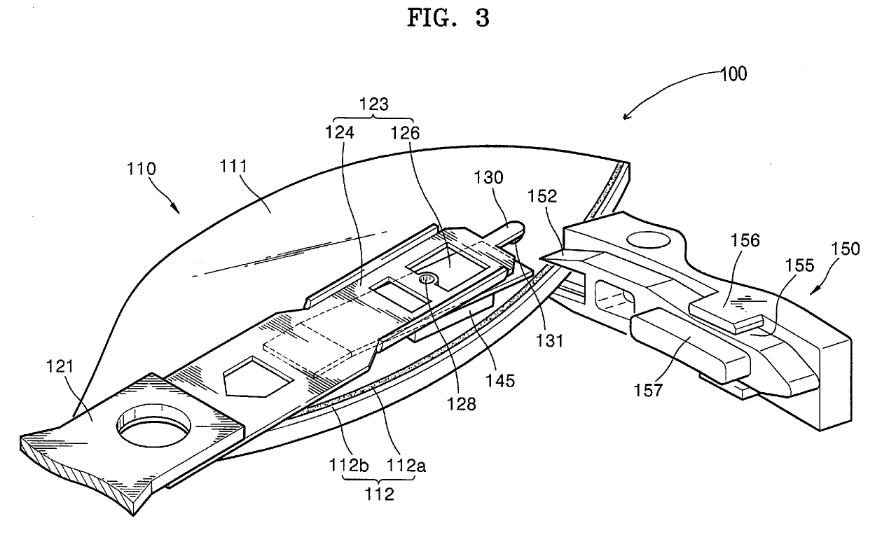

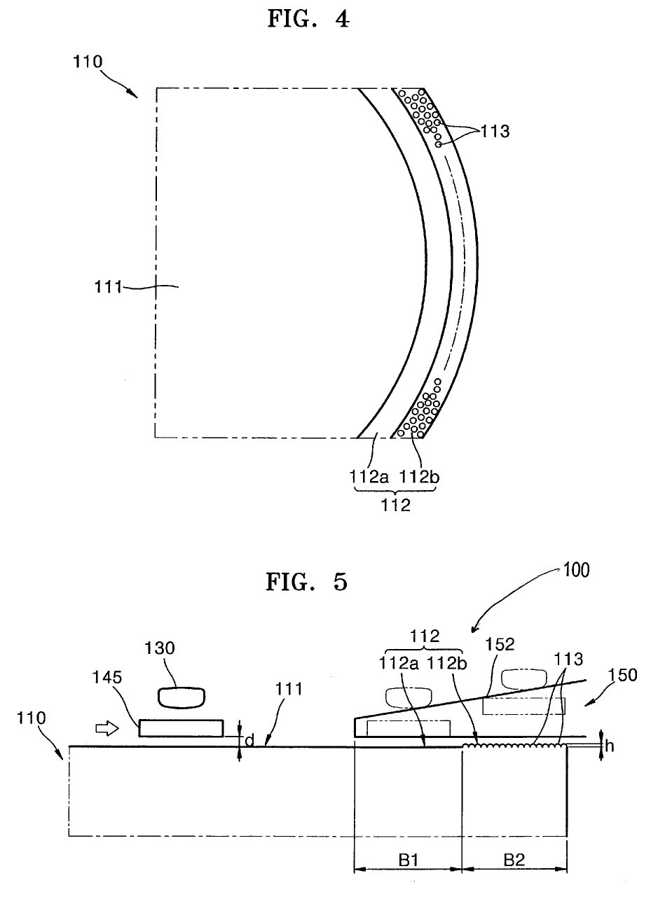

FIGS. 2 and 3 are a plan view and a partial perspective view illustrating a hard disk drive (HDD) 100 in accordance with an embodiment of the present general inventive concept. FIG. 4 is a plan view illustrating a part of a data storing medium 110 of the HDD 100 of FIG. 2, and FIG. 5 illustrates unloading of a magnetic head in the HDD 100 of FIG. 2, in accordance with an embodiment of the present general inventive concept.

Referring to FIGS. 2 through 4, the HDD 100 includes a base member 101, a spindle motor 105 disposed on the base member 101 in a housing that includes the base member 105 and a cover member (not shown), the data storing medium 110 (e.g., a disc), a head stack assembly (HSA) 120, and a voice coil motor (VCM) 118.

The spindle motor 105 rotates the data storing medium 110 with respect to the base member 101. The data storing medium 110 is connected to the spindle motor 105 and rotates at a high speed. The data storing medium 110 includes a recording zone 111 where data is recorded and a non-recording zone 112 outside of the recording zone 111. The non-recording zone 112 includes a boundary region 112a (described below) and a bump region 112b (described below).

The HSA 120 includes a slider 145 (see FIG. 3) with a magnetic head (not shown) to record and/or read data from a surface of the data storing medium 110. The HSA 120 moves the slider 145 to a position on the data storing medium 110 such that data is recorded on the data storing medium 110 by the magnetic head, or data recorded on the data storing medium 110 is read by the magnetic head. The HSA 120 includes a swing arm 121, a suspension 123 fixed to an end of the swing arm 121, and the slider 145 attached to a front of the suspension 123. The HSA 120 is installed on the base member 101 so as to rotate around a pivot center 135.

Referring to FIG. 3, the suspension 123 includes a load beam 124 connected to the end of the swing arm 121 and a flexure 126 which supports the slider 145 and presses the slider 145 toward the surface of the data storing medium 110. The flexture 126 is supported by a dimple 128 that is formed on the load beam 124 to protrude toward the flexure 126. Accordingly, the slider 145 attached to the flexture 126 can move slightly with respect to the load beam 124. An end-tap 130 is arranged at a front end of the load beam 150 to be supported by a ramp 150 and to contact the ramp 150 upon parking of the slider 145. A surface of the end-tap 130 contacts the ramp 150 and includes a raised projection 131 to reduce frictional wear by reducing a contact area between the end-tap 130 and the ramp 150.

Referring to FIGS. 2 to 4, when the data storing medium 110 rotates at a high speed, a lift force is created by the rotation and acts on the slider 145. The slider 145 floats at a height at which the lift force created by the rotation equals an elastic pressure of the suspension 123 that presses the slider 145 toward the data storing medium 110. In this floating state, the magnetic head mounted on the slider 145 reproduces or records data in the recording zone 111 of the data storing medium 110.

The VCM 118 is fixed to the base member 101 and provides the HSA 120 with power to rotate about the pivot center 135. The VCM 118 includes a magnet 118a above and below a VCM coil 137 of the HSA 120, and a yoke 118b to support the magnet 118a. The VCM 118 rotates the HSA 120 controlled by a servo control system in a direction according to Fleming's Left Hand Rule by an interaction of a current input to the VCM coil 137 and a magnetic field created by the magnet 118a.

When the operation of the HDD 100 stops, the VCM 118 rotates the HSA 120 clockwise, so that the slider 145 moves from a loaded state positioned in the recording zone 111 of the data storing medium 110 to the ramp 150 so as to be in an unloaded state (i.e., parked). On the other hand, when the operation of the HDD 100 starts, the VCM 118 rotates the HSA 120 counter-clockwise so that the slider 145 moves from the unloaded state where the slider 145 is parked on the ramp 150 to the loaded state positioned in the recording zone 111 of the data storing medium 110.

When the slider 145 is parked on the ramp 150 and the HSA 120 is arbitrarily rotated by external impact or shaking, the slider 145 and data storing medium 110 may be damaged by colliding with each other. Thus, the HSA 120 can be locked at a predetermined position such that the HSA 120 does not arbitrarily rotate while the slider 145 is parked on the ramp 150. Accordingly, the HDD 100 can include a latch (not shown).

A flexible printed circuit (FPC) 116 is connected to the HSA 120. A FPC bracket 115 positioned at a corner of the base member 101 may connect the FPC 116 with a main circuit board (not shown) underlying the base member 101. A circular filter 107 is positioned at a corner of the base member 101 diagonally opposite to the FPC bracket 115 to filter foreign substances such as particles from air within the HDD 100.

The ramp 150 where the slider 145 is parked (when the operation of the HDD 100 stops) is arranged at an outer edge of the data storing medium 110 and is fixed to the base member 101. Referring to FIGS. 3 and 4, the ramp 150 includes a slope 152 which is inclined such that the end-tap 130 is spaced from the surface of the data storing medium 110 as the end-tap 130 moves to the outer edge of the data storing medium 110, and an end-tap stop face 155 where the end-tap 130 stops. The ramp 150 also includes a slider support face 157 to support the parked slider 145 as the end-tap 130 stops on the end-tap stop face 155, and a breakaway prevention wall 156 to prevent the end-tap 130 from breaking away from the end-tap stop face 155 in the event of an external impact.

Referring to FIGS. 2 to 4, the non-recording zone 112 of the data storing medium 110 includes the bump region 112b where micro bumps (or irregularities) 113 are distributed. As illustrated in FIGS. 3 and 5, the bump region 112b overlaps an end of the ramp 150 where the slope 152 is formed and is adjacent to the outer edge of the data storing medium 110. The non-recording zone 112 further includes the boundary region 112a arranged between the recording zone 111 and the bump region 112b. The boundary region 112a and the bump region 112b are formed as concentric rings of the data storing medium 110.

Referring to FIG. 5, the micro bumps 113 may be formed by irradiating laser light onto the surface of the data storing medium 110 to expand the surface. Various shapes of micro bumps 113 can be formed according to wavelength and intensity of the laser light. The laser may be irradiated such that the micro bumps 113, which are 0.1 μm or less in height, can be formed. The non-recording zone 112 may be made narrow in order to increase the amount of data storage, and a width B1 of the boundary region 112a and a width B2 of the bump region 112b may each be 0.23 mm or less. The width of 0.23 mm corresponds to a width of the slider 145 of a small HDD (e.g., the HDD 100) with a data storing medium 110 having a diameter of 0.85 inches or less. Although the present embodiment is described with reference to the small HDD 100, it should be understood that the HDD 100 may have a variety of different sizes.

Referring to FIGS. 2 through 5, when the operation of the HDD 100 stops, the HSA 120 rotates clockwise to unload the slider 145, and moves the slider 145 from the recording zone 111 of the data storing medium 110 to the non-recording zone 112. As the spindle motor 105 stops rotating the data storing medium 110, the rotation speed of the data storing medium 110 converges to zero, and the lift force of the slider 145 decreases. However, a suction force (i.e., an attraction force) which attracts the slider 145 toward the surface of the data storing medium 110 in the non-recording zone 112 is prevented from increasing by the micro bumps 113 of the bump region 112b.

Positive pressure that pushes the slider 145 away from the surface of the data storing medium 110 and negative pressure acting in an opposite direction (i.e., toward the surface of the data storing medium 110) are generated on a side of the slider 145 facing the surface of the data storing medium 110. A resultant force of the positive pressure and the negative pressure causes the slider 145 to float above the surface of the data storing medium 110. The lift force (i.e., a floating force) decreases as a roughness of the surface of the data storing medium 110 becomes greater. Thus, an increase in the suction force attracting the slider 145 toward the surface of the data storing medium 110 (i.e., the negative pressure) is also restricted by the micro bumps 113 of the bump region 112b.

By decreasing the suction force as described above, the end-tap 130 of the HSA 120 collides with the slope 152 of the ramp 150 at an appropriate speed such that a release of particles is minimized, and the end-tap 130 moves up the slope 152 and stops on the end-tap stop face 155, and the slider 145 safely and stably arrives on the slider support face 157.

In the small HDD 100 where a diameter of the data storing medium 110 is 0.85 inches or less, a floating height of the slider 145 is 0.4 cm or less, and the slider 145 is shaken up and down within a narrow range by an impact caused when the end-tap 130 collides with the slope 152. Since the boundary region 112a of the data storing medium 110 does not include the micro bumps 113 and has the same surface height as the recording zone 111, the possibility that the slider 145 is damaged by colliding with the surface of the data storing medium 110 is decreased.

The HDD with the data storing medium of the embodiments of the present general inventive concept enables a slider to be stably unloaded from a recording zone of the data storing medium. Further, it is possible to prevent an unloading failure of the slider without increasing a rotation speed of a head stack assembly, thereby preventing particles from being released when an end-tap collides with a ramp at which the slider is parked.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A data storing medium, comprising:
a recording zone where data is recorded and/or reproduced; and
a non-recording zone disposed outside the recording zone to overlap with an end of a ramp at which a slider with a magnetic head is parked, the non-recording zone including a plurality of micro bumps formed thereon to reduce adsorption between the slider and a surface of the data storing medium.

2. The data storing medium of claim 1, wherein the micro bumps are formed by irradiating laser light onto the surface of the data storing medium.

3. The data storing medium of claim 1, wherein the micro bumps are 0.1 μm or less in height.

4. The data storing medium of claim 1, wherein the non-recording zone comprises:
a bump region adjacent to an outer edge of the data storing medium and having the micro bumps distributed therein; and
a boundary region arranged between the recording zone and the bump region.

5. The data storing medium of claim 4, wherein the bump region is 0.23 mm or less in width.

6. The data storing medium of claim 4, wherein the boundary region is 0.23 mm or less in width.

7. A HDD (hard disk drive) including a disk-shaped data storing medium, a slider with a magnetic head to record and/or read data to/from the data storing medium, and a ramp arranged at an outer edge of the data storing medium on which the slider is parked, the data storing medium comprising:
a recording zone where data is recorded and/or read by the magnetic head; and
a non-recording zone arranged outside of the recording zone to overlap with an end of the ramp and having a plurality of micro bumps to prevent adsorption between the slider and a surface of the data storing medium.

8. The HDD of claim 7, wherein the micro bumps are formed by irradiating laser light onto the surface of the data storing medium.

9. The HDD of claim 7, wherein the micro bumps are 0.1 μm or less in height.

10. The HDD of claim 7, wherein the non-recording zone comprises:
a bump region adjacent to an outer edge of the data storing medium and having the micro bumps distributed therein; and
a boundary region arranged between the recording zone and the bump region.

11. The HDD of claim 10, wherein the bump region is 0.23 mm or less in width.

12. A hard disk drive, comprising:
a hard disc including a recording region in which data is recordable and readable, and a non-recording region disposed around the recording region and having a plurality of irregularities formed thereon;
a slider having a magnetic head associated therewith and being movable along the recording and non-recording regions of the hard disc; and
a ramp on which the slider is parkable when the hard disk drive is powered off and having a slope extending over a surface of the non-recording region.

13. The hard disk drive of claim 12, wherein when the hard disk drive is powered off, a lift force is decreased and a suction force is created between the hard disc and the slider, and the suction force is minimized in the non-recording region by the irregularities.

14. The hard disk drive of claim 12, wherein the plurality of irregularities comprise micro bumps extending from a surface of the non-recording region.

15. The hard disk drive of claim 12, wherein the hard disc is less than or equal to 0.85 inches in diameter.

16. The hard disk drive of claim 12, wherein the irregularities in the non-recording region regulate a force between the disc and a slider such that an end tap of the slider impacts a slope of the ramp at an appropriate speed such that particles generated by the impact are minimized.

17. The hard disk drive of claim 12, wherein the non-recording region comprises a bump region in which the irregularities are formed and a width of the bump region corresponds to a width of the slider.

18. A method of manufacturing a hard disc usable with a hard disk drive, the method comprising:
irradiating a laser onto an outer ring of the hard disc to expand a surface of the hard disc such that a plurality of bumps are formed in the outer ring of the hard disc.

19. The method of claim 18, wherein the bumps are made to have a height of about one micrometer with respect to the surface of the hard disc.
